(19) United States
(12) Patent Application Publication
(10) Pub. No.: US 2012/0063695 A1
(43) Pub. Date: Mar. 15, 2012

(54) METHODS FOR ENCODING A DIGITAL PICTURE, ENCODERS, AND COMPUTER PROGRAM PRODUCTS

(76) Inventors: Dajun Wu, Singapore (SG); Wei Siong Lee, Singapore (SG); Jo Yew Tham, Singapore (SG); Kwong Huang Goh, Singapore (SG); Susanto Rahardja, Singapore (SG)

(21) Appl. No.: 13/124,257

(22) PCT Filed: Oct. 15, 2009
(86) PCT No.: PCT/SG2009/000377

§ 371 Date: Aug. 12, 2011

Related U.S. Application Data
(60) Provisional application No. 61/105,497, filed on Oct. 15, 2008.

(51) Int. Cl. G06K 9/36

(52) U.S. Cl. 382/238

(57) ABSTRACT

In one embodiment, a method for encoding a digital picture of a sequence of digital pictures is provided, the digital picture comprising a plurality of pixels, wherein the plurality of pixels is associated at least partially with a first group of pixels and the plurality of pixels or a plurality of pixels of another digital picture is associated at least partially with at least one second group of pixels. The method comprises determining, for the second group of pixels, a second group of pixels coding mode, determining, for the first group of pixels, based on the second group of pixels coding mode, a first group of pixels coding mode, and encoding the digital picture using the first group of pixels coding mode for the first group of pixels.

### FIELD OF THE INVENTION

Embodiments of the invention generally relate to methods for encoding a digital picture, encoders, and computer program products.

### BACKGROUND OF THE INVENTION

Recently, scalable video coding (SVC) has been standardized as a scalable extension of the ISO/IEC international standard on H.264/MPEG-4 Advanced Video Coding. In SVC, specific video bit streams can be obtained by utilizing different presentation functionalities such as spatial, temporal, and quality scalability.

According to SVC, a base layer and multiple enhancement layers are generated using similar video coding methods as in H.264. In addition, inter-layer prediction is also exploited in order to maximize encoding efficiency. For spatial scalability in SVC, each enhancement layer contains information needed to construct a higher resolution frame from the base layer.

In SVC, there are five macro block coding modes for P-macro blocks and 23 macro block coding modes for B-macro blocks. Each of these modes corresponds to a Certain spatial macro block partitioning pattern and motion prediction direction, i.e., forward, backward or bidirectional, for the macro block.

In order to achieve optimal coding efficiency in SVC, rate-distortion cost is typically calculated for all possible modes in each macro block. The mode that has the minimum RD (rate-distortion) cost is usually selected. Consequently, the encoder complexity may be prohibitively high for software implementation due to the mode selection process. Thus, fast algorithms are needed for coding mode decisions.

A variety of fast mode decision approaches have been proposed for H.264. They aim at reducing encoding complexity with little PSNR (peak signal to noise ratio) and little bit rate increase for single layer coding. However, it is difficult to apply these methods to SVC, especially to enhancement layers. In view of this, fast mode decision algorithms for enhancement layers have been proposed.

For example, a fast mode decision for spatial scalable coding has been proposed where the macro block sub-block partitioning in the enhancement layer is predicted from the base layer. This limits the candidate prediction modes for enhancement layers to a smaller subset and reduces the encoder computational complexity.

An object on which embodiments may be seen to be based is to provide an encoding method allowing reduced complexity of encoders.

### SUMMARY OF THE INVENTION

In one embodiment, a method for encoding a digital picture of a sequence of digital pictures is provided, the digital picture comprising a plurality of pixels, wherein the plurality of pixels is associated at least partially with a first group of pixels and the plurality of pixels is associated at least partially with at least one second group of pixels. The method comprises determining, for the second group of pixels, a second group of pixels coding mode specifying whether pixel information of the pixels associated with the second group of pixels is to be predicted based on
pixel information of a digital picture preceding the digital picture or
pixel information of a digital picture following the digital picture or
pixel information of both a digital picture preceding the digital picture and pixel information of a digital picture following the digital picture;

determining, for the first group of pixels, based on the second group of pixels coding mode, a first group of pixels coding mode specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel information of a digital
picture following the digital picture; and

encoding the digital picture using the first group of pixels coding mode for the first group of pixels.

In another embodiment, a method for encoding a digital picture of a sequence of digital pictures is provided, the digital picture comprising a plurality of pixels, wherein the plurality of pixels is associated at least partially with a first group of pixels and another plurality of pixels of another digital picture is associated at least partially with at least one second group of pixels, the method comprising determining, for the second group of pixels, a second group of pixels coding mode specifying whether pixel information of the pixels associated with the second group of pixels is to be predicted based on
pixel information of a digital picture preceding the other digital picture or
pixel information of a digital picture following the other digital picture or
pixel information of both a digital picture preceding the other digital picture and pixel information of a digital picture following the other digital picture;
   determining, for the first group of pixels, based on the second group of pixels coding mode, a first group of pixels coding mode specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel information of a digital
picture following the digital picture; and
   encoding the digital picture using the first group of pixels coding mode for the first group of pixels.

According to other embodiments, an encoder and a computer program product according to the method for encoding a digital picture described above are provided. Embodiments described in the following in connection with one of the methods for encoding a digital picture are analogously valid for the other method for encoding a digital picture, the encoders and the computer program products.

### SHORT DESCRIPTION OF THE FIGURES

Illustrative embodiments of the invention are explained below with reference to the drawings.

FIG. 1 shows an encoder according to an embodiment.

FIG. 2 shows a group of pictures (GOP) for which a hierarchical-B structure is used.

FIG. 3 shows a flow diagram according to an embodiment.

FIG. 4 shows an encoder according to an embodiment.

FIG. 5 shows a base layer macro block arrangement of a frame and an enhancement layer macro block arrangement of the frame.

### DETAILED DESCRIPTION

SVC (scalable video coding) may be seen as very complex because of the following factors: 1) different layers are encoded; and 2) the advanced coding methods applied to H.264 are used. Additionally, in order to achieve optimum coding efficiency, rate distortion optimization (RDO) is used for deciding the coding mode for each MB (macro block) based on intensive computation. Specifically, all possible coding modes for a macro block are examined before the one leading to the least rate distortion cost is selected as the best coding mode for the macro block. Therefore, SVC may be seen to achieve optimal coding efficiency at the expense of very high computational complexity.

According to one embodiment, a coding method is provided by which a lower complexity than the one of conventional SVC may be achieved while causing only little quality degradation with respect to conventional SVC.

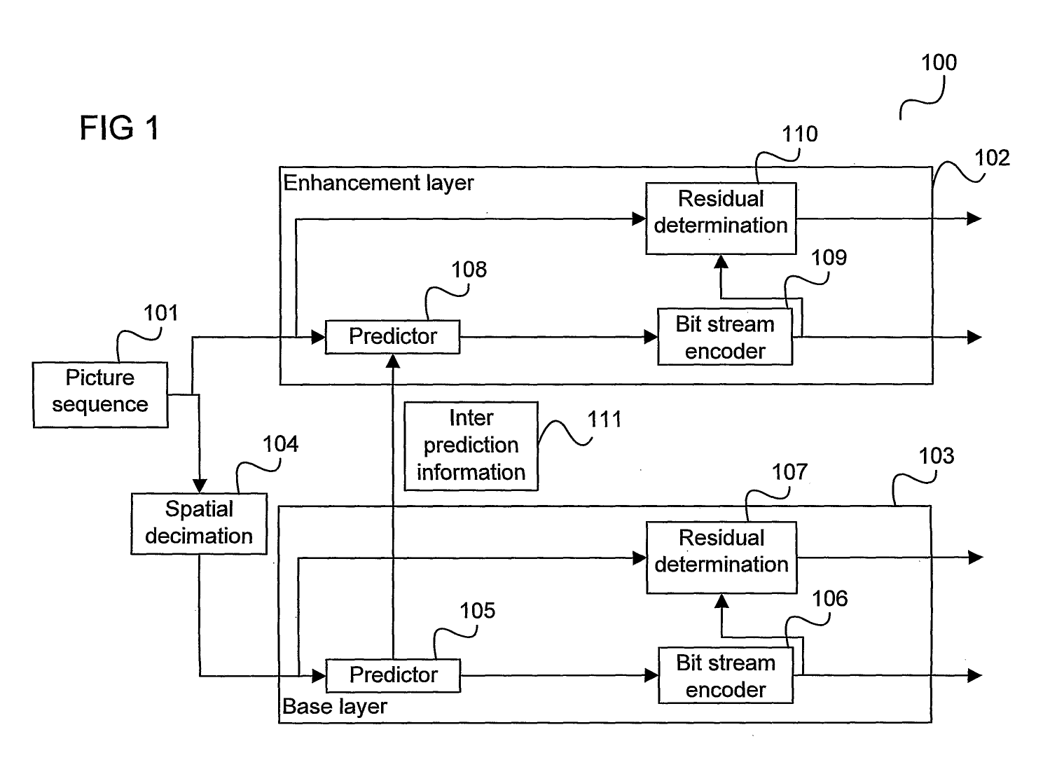

FIG. 1 shows an encoder 100 according to an embodiment.

The encoder 100 receives a digital picture sequence 101 comprising a plurality of temporally ordered digital pictures (also referred to as frames) as input..

The digital picture sequence 101 is supplied to a (spatial) enhancement layer block 102 and a (spatial) base layer block 103.

The input of the enhancement layer block 102 and the base layer block 103 may differ in spatial resolution. For example, the spatial resolution of the digital picture sequence 101 is reduced by a spatial decimation circuit 104 before it is fed to the base layer block 103.

For example, a base layer frame size is one-quarter of the size of an enhancement layer frame. For example, QCIF-size (176×144) is used for the base layer while CIF-size (352×288) is the original frame size and is used for the enhancement layer. As another example, CIF-size frames are fed to the base layer for 4CIF-size (704×576) frames of the digital picture sequence 101.

A digital picture fed to the base layer block 103 is supplied to a first prediction circuit 105 that generates prediction information for the digital picture. For example, the first prediction circuit 105 determines motion vectors based on which the digital picture may be approximated using a previous or a following digital picture in the picture sequence 101. The output of the first predictor 105 is fed to a first bit stream coding circuit 106 which generates a first coding bit-stream, for example a H.264/AVC compatible base layer bit-stream.

The output of the first bit stream coding circuit 106 and the digital picture is further supplied to a first residual determination circuit 107 which calculates the residuals of the prediction of the digital picture, i.e. which generates information from which the errors made in the approximation of the digital picture by the prediction may be determined.

Similarly, a digital picture fed to the enhancement layer block 102 is supplied to a second prediction circuit 108 that generates prediction information for the digital picture. The output of the second predictor 108 is fed to a second bit stream coding circuit 109 which generates a second coding bit-stream, for example a H.264/AVC compatible base layer bit-stream.

The output of the second bit stream coding circuit 109 and the digital picture is further supplied to a second residual determination circuit 110 which calculates the residuals of the prediction of the digital picture.

In the prediction of the digital picture in the enhancement layer (i.e. at higher resolution) inter prediction information 111 from the prediction of the digital picture in the base layer (i.e. at lower resolution) may be used. For example, the enhancement layer prediction information may be determined based on the reconstruction of the digital picture from the coding information generated by the base layer block 103, e.g. by up-sampling the reconstructed base layer picture.

For the prediction, both the first prediction circuit 105 (i.e. the prediction circuit of the base layer) and the second prediction circuit 108 (i.e. the prediction circuit of the enhancement layer) may use motion estimation.

In scalable video coding, motion estimation is one of the most computationally intensive modules. Profiling results (e.g. using Intel VTune profiling tool to analyze the JSVM 8.10 software) reveal that the hot spot functions such as SAD (sum of absolute difference) calculation, search position examination, etc. are highly related to motion estimation and are computationally intensive due to the number of computation steps for each search position. According to one embodiment, motion estimation complexity is reduced which contributes significantly to reducing the overall encoder complexity.

In one embodiment, the digital pictures of the digital picture sequence 101 are grouped into consecutive groups of pictures (GOP) and a hierarchical-B structure is used in coding a group of pictures. Such a hierarchical-B structure allows an elegant presentation of temporal scalability.

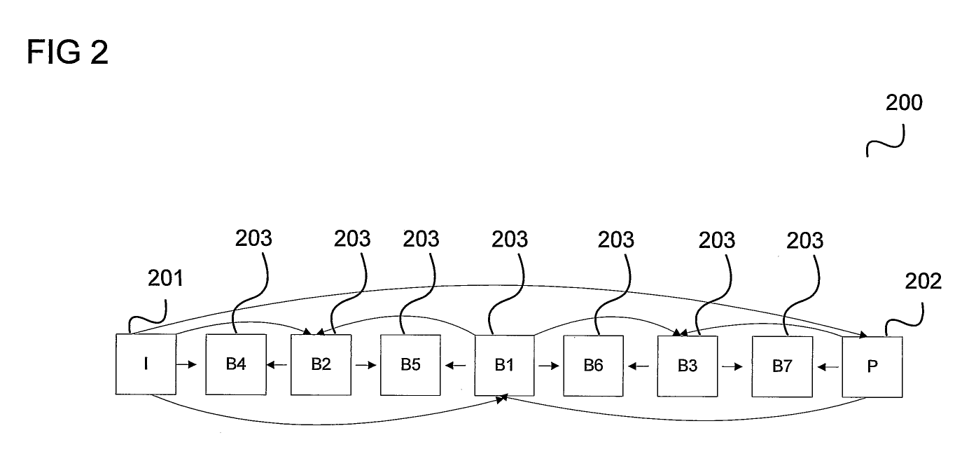

Unlike the ordinary B-frame which cannot be used to predict other frames, hierarchical-B frames can be used as reference frames. One example of a hierarchical-B structure is illustrated in FIG. 2.

FIG. 2 shows a group of pictures (GOP) 200 for which a hierarchical-B structure is used.

The GOP 200 comprises a plurality of frames 201, 202, 203. An I-frame 201, a P-frame 202 and a plurality of B-frames 203.

The numbers of the B-frames denotes the order in which they are encoded.

Arrows indicate which frames 201, 202, 203 may be used for prediction of another frame 201, 202, 203. An arrow starting from a first frame 201, 202, 203 and ending at a second frame 201, 202, 203 indicates that the first frame may be used for predicting the second frame 201, 202, 203 in the GOP by motion estimation.

This prediction hierarchy is for example used by the first prediction circuit 104 and the second prediction circuit 108 for a digital picture (frame) of a GOP to be encoded.

For example, frame B2 (as indicated by the arrows) can be predicted using frames I and B1. Frame B5 can be predicted using frames B1 and B2. Whilst seven B-frames are used in the example, GOPs using another number of B-frames can be used to produce a different number of temporal layers. It can be seen that, when compared to traditional B-frames, hierarchical-B frames may have much higher motion estimation complexity due to the long temporal distance between the reference frames and the current frame to be coded.

As can be seen in FIG. 2, each B-frame 203 may be predicted using two other frames 201, 202, 203, wherein one of the other frames is a frame 201, 202, 203 preceding the B-frame 203 and the other is a frame 201, 202, 203 preceding the B-frame 203.

For each macro block in such a B-frame 203, it may be examined whether forward prediction (i.e. prediction based on previous frame in the GOP), backward prediction (i.e. prediction based on a following frame in the GOP), or bi-directional prediction (i.e. prediction based on both the preceding and the following frame in the GOP) should be used. This prediction mode for a macro block of the B-frame 203, i.e. whether forward prediction, backward prediction or bi-directional prediction is used, is also denoted as the coding direction of the macro block.

For example, as in SVC, the coding direction and the motion vectors leading to the least (optimum) cost for the macro block are set as the optimum coding direction and the motion vectors and are used for the encoding. Further, the possible inter coding modes (i.e. prediction using other frames of the GOP) may be compared with the intra coding mode (i.e. coding the frame without prediction using other frames) to decide whether to choose inter coding mode or intra coding mode as the optimum mode for a macro block.

The hierarchical-B GOP structure and motion estimation using forward, backward, or bi-directional prediction may be used in the base layer and in one or more enhancement layers. Since these features highly contribute to the complexity of the whole encoding process, a way to reduce the motion estimation complexity is provided in one embodiment.

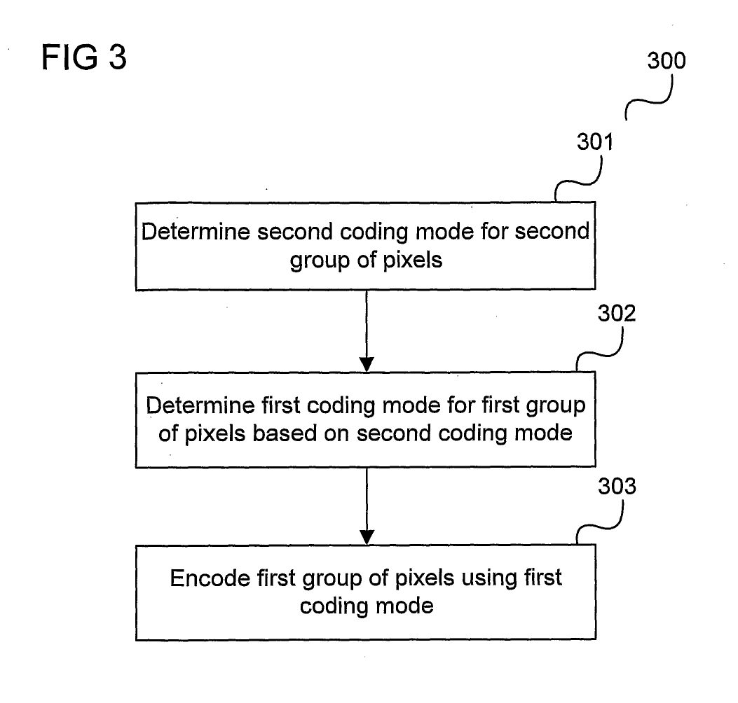

This is explained in the following with reference to FIG. 3.

FIG. 3 shows a flow diagram 300 according to an embodiment.

The flow illustrated in FIG. 3 illustrates a method for encoding a digital picture of a sequence of digital pictures, the digital picture comprising a plurality of pixels, wherein the plurality of pixels is associated at least partially with a first group of pixels and the plurality of pixels is associated at least partially with at least one second group of pixels.

In 301, a second group of pixels coding mode is determined for the second group of pixels specifying whether pixel information of the pixels associated with the second group of pixels is to be predicted based on
pixel information of a digital picture preceding the digital picture or
pixel information of a digital picture following the digital picture or
pixel information of both a digital picture preceding the digital picture and pixel information of a digital picture following the digital picture.

In 302, a first group of pixels coding mode is determined for the first group of pixels based on the second group of pixels coding mode specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel information ‘of a digital picture following the digital picture.

In 303, the digital picture is encoded using the first group of pixels coding mode for the first group of pixels.

Additionally, the digital picture may be encoded using the second group of pixels coding mode for the second group of pixels.

In an alternative embodiment, the second group of pixels is not a group of pixels of the digital picture to be encoded itself, but is a group of pixels of another digital picture, e.g. a digital picture of the sequence of digital pictures preceding or following the digital picture to be encoded. In this case another plurality of pixels of another digital picture is associated at least partially with at least one second group of pixels.

In this alternative embodiment, in 301, a second group of pixels coding mode is determined for the second group of pixels, specifying whether pixel information of the pixels associated with the second group of pixels is to be predicted based on
pixel information of a digital picture’ preceding the other digital picture or
pixel information of a digital picture following the other digital picture or
pixel information of both a digital picture preceding the other digital picture and pixel information of a digital picture following the other digital picture.

Following 301 according to the alternative embodiment, 302 and 303 may be carried out as described above.

The other digital picture may for example be the digital picture directly preceding the digital picture to be encoded in the digital picture sequence or the digital picture directly following the digital picture to be encoded in the digital picture sequence. The other digital picture may also be a digital picture in the digital picture sequence that may be used for motion estimation of the digital picture to be encoded.

In other words, for example, the coding mode (also referred to as coding direction mode) to be used for a first group of pixels is determined based on the direction mode used for one or more second groups of pixels, for example one or more spatially neighbouring groups of pixels, one or more temporally neighbouring groups of pixels (i.e. groups of pixels of other digital pictures preceding or following the digital picture to be encoded) and/or groups of pixels of another coding layer, such as a base layer in case the first group of pixels is a group of pixels of an enhancement layer.

For example, motion estimation (ME) complexity in the enhancement layer may be reduced by using knowledge of the motion prediction modes in both the base layer and the enhancement layer (e.g. from spatially or temporally neighbouring groups of pixels) such that motion estimation mode trials can be avoided.

Each group of pixels for example covers a continuous area of the digital picture. The size and shape of the continuous area is for example equal for all groups of pixels. The groups of pixels are for example blocks.

In one embodiment, each group of pixels is a macro block.

In one embodiment, the plurality of pixels is associated at least partially with a plurality of second groups of pixels, wherein the second group of pixels is one of the plurality of second groups of pixels. In this embodiment, the method may further comprise determining, for each of the second groups of pixels, a second group of pixels coding mode specifying whether pixel information of the pixels associated with the second group of pixels is to be predicted based on pixel information of a digital picture preceding the digital picture or
pixel information of a digital picture following the digital picture or
pixel information of both a digital picture preceding the digital picture and pixel information of a digital
picture following the digital picture;
   and the first group of pixels coding mode may be determined based on the second group of pixels coding modes determined for the second groups of pixels.

A plurality of second groups of pixels may analogously be used in case that one or more of the second groups of pixels are not of the digital picture to be encoded itself but of another digital picture as in 301 according to the alternative embodiment described above. In this case, second coding modes maybe determined for the second groups of pixels as described above for the second group of pixels of the other digital picture.

In one embodiment, at least one of the second groups of pixels is of the digital picture to be encoded and at least one of the second groups of pixels is of the other digital picture. Second coding modes may be determined for such second groups of pixels as described above.

In other words, the embodiment and the alternative embodiment described above with reference to FIG. 3 may be combined using a plurality of second groups of pixels.

It should be noted that a group of pixels being “of” a digital picture may be understood to mean that the group of pixels is associated with pixels of the digital picture.

The second groups of pixels are for example associated with different pixels of the plurality of pixels. In other words, the second groups of pixels are pair wise different with regard to the pixels that are associated with the second groups of pixels.

For example, the second groups of pixels are associated with disjoint subsets of the plurality of pixels. For example, the second groups of pixels disjointly cover a part of the digital picture.

The first group of pixels coding mode may for example be determined based on a comparison of the second group of pixels coding modes.

For example, it is checked whether one coding mode is equal to a majority of second group of pixels coding modes and wherein, if one coding mode is equal to a majority of second group of pixels coding modes, this coding mode is selected as the first group of pixels coding mode.

In one embodiment, the first group of pixels is a group of pixels of a first coding layer corresponding to a first coding quality and the second group of pixels is a group of pixels of a second coding layer corresponding to a second coding quality. For example, the second coding layer is a base layer and the first coding layer is an enhancement layer. This may be analogously the case for each of a plurality of second groups of pixels as above.

In one embodiment, the second group of pixels is associated with at least partially the same pixels as the first group of pixels.

In an embodiment where the second group of pixels is a group of pixels of another digital picture and not of the digital picture to be encoded itself, the second group of pixels may be associated with at least partially the pixels of the other digital picture that correspond to the pixels of the digital picture with which the first group of pixels is associated. A pixel of the digital picture may be seen to correspond to another pixel in the other digital picture if it has the same location in the digital picture as the other pixel in the other digital picture. In an embodiment where the second group of pixels is a group of pixels of another digital picture and not of the digital picture to be encoded itself, the second group of pixels may be associated with pixels of the other digital picture neighbouring the pixels that correspond to the pixels of the digital picture with which the first group of pixels is associated.

In one embodiment, the second group of pixels is associated with pixels adjacent to the pixels associated with the first group of pixels. This may be analogously the case for a plurality of second groups of pixels for which a second coding mode is determined (see above).

In one embodiment, the second group of pixels coding mode is a second motion estimation coding direction mode specifying whether pixel information of the pixels associated with the second group of pixels is to be predicted based on a motion estimation using
pixel information of a digital picture preceding the digital picture or
pixel information of a digital picture following the digital picture or
pixel information of both a digital picture preceding the digital picture and pixel information of a digital picture following the digital picture.

In an embodiment where the second group of pixels is a group of pixels of another digital picture and not of the digital picture to be encoded itself, the second group of pixels coding mode may be a second motion estimation coding direction mode specifying whether pixel information of the pixels associated with the second group of pixels is to be predicted based on a motion estimation using
pixel information of a digital picture preceding the other digital picture or
pixel information of a digital picture following the other digital picture or
pixel information of both a digital picture preceding the digital picture and pixel information of a digital picture following the digital picture.

In one embodiment, the first group of pixels coding mode is a first motion estimation coding direction mode specifying whether pixel information of the pixels associated with the first group of pixels is to be predicted based on a motion estimation using
pixel information of a digital picture preceding the digital picture or
pixel information of a digital picture following the digital picture or
pixel information of both a digital picture preceding the digital picture and pixel information of a digital picture following the digital picture.

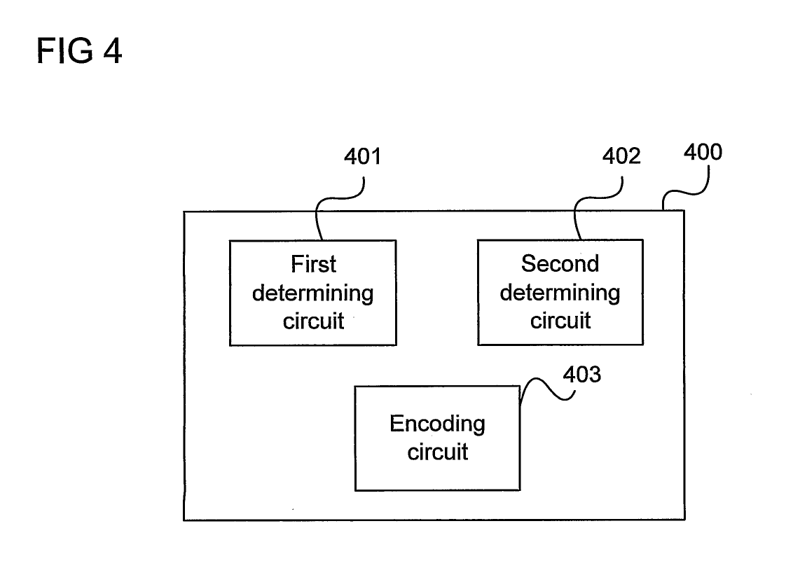

The method illustrated in FIG. 3 may for example be carried out by an encoder as illustrated in FIG. 4.

FIG. 4 shows an encoder 400 according to an embodiment.

The encoder 400 is configured to encode a digital picture of a sequence of digital pictures, the digital picture comprising a plurality of pixels, wherein the plurality of pixels is associated at least partially with a first group of pixels and the plurality of pixels is associated at least partially with at least one second group of pixels.

The encoder 400 comprises a first determining circuit 401 configured to determine, for the second group of pixels, a second group of pixels coding mode specifying whether pixel information of the pixels associated with the second group of pixels is to be predicted based on
pixel information of a digital picture preceding the digital picture or
pixel information of a digital picture following the digital picture or
pixel information of both a digital picture preceding the digital picture and pixel information of a digital picture following the digital picture.

Further, the encoder 400 comprises a second determining circuit 402 configured to determine, for the first group of pixels, based on the second group of pixels coding mode, a first group of pixels coding mode specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel information of a digital picture following the digital picture.

The encoder 400 further comprises an encoding circuit 403 configured to encode the digital picture using the first group of pixels coding mode for the first group of pixels.

In the alternative embodiment mentioned above with reference to FIG. 3, in which the second group of pixels is not a group of pixels of the digital picture to be encoded itself, but is a group of pixels of another digital picture, e.g. a digital picture of the sequence of digital pictures preceding or following the digital picture to be encoded. In this case another plurality of pixels of another digital picture is associated at least partially with at least one second group of pixels.

According to such an alternative embodiment, the first determining circuit 301 may be configured to determine a second group of pixels coding mode for the second group of pixels, specifying whether pixel information of the pixels associated with the second group of pixels is to be predicted based on
pixel information of a digital picture preceding the other digital picture or
pixel information of a digital picture following the other digital picture or
pixel information of both a digital picture preceding the other digital picture and pixel information of a digital picture following the other digital picture.

The encoder 400 may for example have the structure of the encoder 100 shown in FIG. 1, wherein the first determining circuit 401 and the second determining circuit 402 may be part of the first prediction circuit 105 or the second prediction circuit 108, depending on whether the first group of pixels is a group of pixels of the base layer or a group of pixels of the enhancement layer and depending on whether the second group of pixels is a group of pixels of the base layer or a group of pixels of the enhancement layer. In case that the second group of pixels is a group of pixels of the base layer and the first group of pixels is a group of pixels of the enhancement layer, the information about the second group of pixels coding mode is for example part of the inter prediction information 111.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment. A computer program product is for example a computer readable medium on which instructions are recorded which may be executed by a computer, for example including a processor, a memory, input/output devices etc.

As explained above, the picture sequence 101 may be supplied to the base layer block 103 at a lower resolution than to the enhancement layer block. This is for example done according to a dyadic spatial scalability, such that a macro block M_{j,i}^{0,t} positioned j^{th} row and i^{th} column of a frame with time index t in the base layer (layer index 0) corresponds to four macro blocks {M_{2j,2i}^{1,t}, M_{2j,2i+1}^{1,t}, M_{2j+1,2i+1}^{1,t}} in the enhancement layer (layer index 1, time index t).

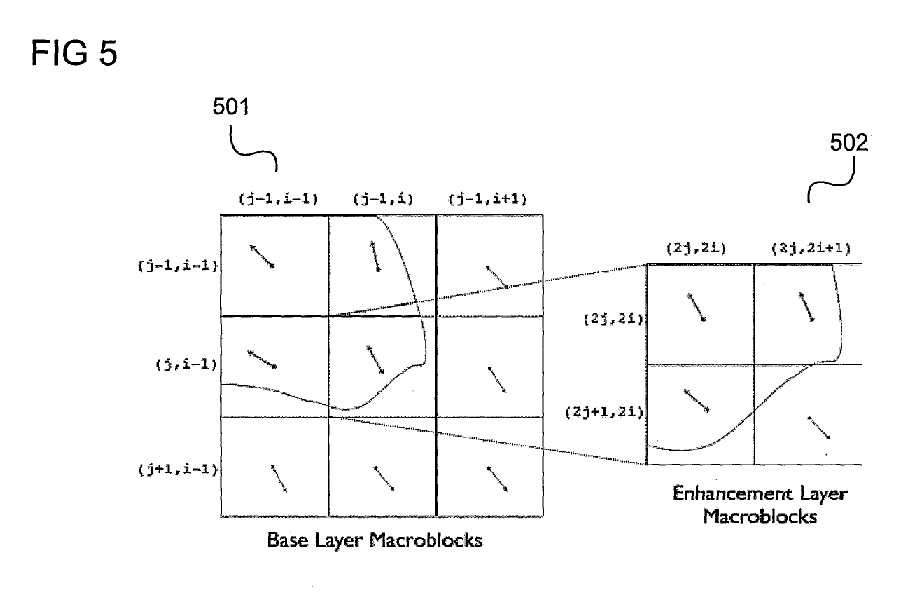

The macro block correspondence relationship between the base layer and the enhancement layer is illustrated in FIG. 5.

FIG. 5 shows a base layer macro block arrangement 501 of a frame and an enhancement layer macro block arrangement 502 of the frame.

The base layer macro block arrangement 501 for example forms a part of digital picture (frame) as it is supplied to the base layer coding block 103. It comprises nine base layer macro blocks which are arranged in three rows and three columns such that each macro block may be identified by its row number (going from j−1 to j+1 in this example) and its column number (going from i−1 to i+1 in this example).

The enhancement layer macro block arrangement 502 for example forms a part of digital picture (frame) as it is supplied to the base layer coding block 103. It comprises four macro blocks M_{2j,2i}^{1,t}, M_{2j,2i+1}^{1,t}, M_{2j+1,2i}^{1,t}, M_{2j+1,2i+1}^{1,t} corresponding to the base layer macro block M_{j,i}^{1,t} positioned at the j^{th} row and i^{th} column of the base layer macro block arrangement 501. Note that because of the double resolution of the enhancement layer in both rows and columns in this example, the base layer macro block M_{j,i}^{0,t} positioned at the j^{th} row and i^{th} column will correspond to the enhancement layer macro blocks positioned at the 2j^{th} row and 2i^{th} column, the 2j+1^{th} row and i^{th} column, the 2j^{th} row and 2i+1^{th} column, and the 2j+1^{th} row and 2i+1^{th} column.

Since each quad-set of macro blocks in the enhancement layer is collectively a higher resolution version of the corresponding blocks at the base layer, the motion estimation coding direction is likely to be correlated between these macro blocks across the layers as well as in the spatial vicinity.

Therefore, in one embodiment, when performing motion estimation for macro blocks in the enhancement layer, the encoder 100 performs directional estimation based on the motion estimation coding directions of the corresponding macro blocks in the base layer, i.e. can for example skip motion estimation coding directions when determining which coding direction to use depending on which coding direction have been used in the corresponding macro blocks in the base layer. Further, in one embodiment, in order to improve the robustness of encoding scheme, the motion estimation coding direction relationship among neighbouring blocks (relative to the current macro block) at the base layer and at the enhancement layer is exploited.

For example, let D(M) denote the motion estimation direction of a macro block M. Then the motion estimation coding direction mode for the prediction for the macro blocks of the enhancement layer macro block arrangement 502 is given, according to one embodiment, by the following:

D(M_{2j,2i}^{1,t})=Gₗ(D(M_{j,i}^{0,t}), D(M_{j-1,i}^{0,t}), D(M_{j-1,i-1}^{0,t}), D(M_{j,i-1}^{0,t})) (1)

D(M_{2j,2i+1}^{1,t})=Gₗ(D(M_{j,i}^{0,t}), D(M_{j-1,i}^{0,t}), D(M_{j-1,i+1}^{0,t}), D(M_{j,i+1}^{0,t})) (2)

D(M_{2j+1,2i}^{1,t})=Gₗ(D(M_{j,i}^{0,t}), D(M_{j,i-1}^{0,t}), D(M_{j+1,i-1}^{0,t}), D(M_{j+1,i}^{0,t})) (3)

D(M_{2j+1,2i+1}^{1,t})=Gₗ(D(M_{j,i}^{0,t}), D(M_{j,i+1}^{0,t}), D(M_{j+1,i}^{0,t}), D(M_{j+1,i+1}^{0,t})) (4)

where G₁ is an adaptive cross-layer motion estimation coding direction decision function. Similarly, the motion estimation coding direction mode can be determined based on the coding direction modes of spatial neighbouring macro blocks according to

D(M_{n,m}^{1,t})=Gₛₜ(M_{n-1,m}^{1,t}, M_{n-1,m+1}^{1,t}, M_{n,m-1}^{1,t}, M_{n,m}^{1,t-1}) (5)

where Gₛₜ is an adaptive spatial-temporal motion estimation coding direction decision function (and n,m is used as an index instead of j, i). It should be noted that according to equation (5) the coding direction mode of a macro block M_{n,m}^{1,t-1} of another digital picture than the digital picture to be encoded is taken as the basis for the decision.

An example for a simple choice for both Gₗ and Gₛₜ is “majority” mode decision. This means that the predicted motion estimation coding direction mode is selected such that it is the same as of most of the inter-layer/spatial/temporal neighbouring macro blocks. In the case where no “majority” coding mode can be determined, full direction search is for example used as default, where forward, backward and bi-directional coding modes are tested to determine the optimum coding direction mode.

According to another embodiment, the encoder 100 carries out the following for encoding a frame:
1) Initialize a matrix for recording the motion estimation coding direction of each macro block of the frame at the base layer;
2) After motion estimation for each macro block at the base layer, select the motion estimation coding direction for the block and record the selected motion estimation coding direction in the matrix. For example, record a value of 0 for forward estimation, 1 for backward estimation, and 2 for bi-directional estimation.
3) In the enhancement layer, for each macro block of the enhancement layer, look up the entry in the matrix for the corresponding macro block of the base layer (i.e. the base layer macro block comprising the pixels of the enhancement layer macro block). If the value is 0, choose forward prediction for the enhancement layer macro block. If the value is 1, choose backward prediction for the enhancement layer macro block. If the value is 2, choose bi-directional prediction for the enhancement layer macro block.

The encoding method described above may be implemented using JSVM (Joint Scalable Video Model) version 8.10 software. It has been tested using the test conditions according to table 1.

TABLE 1

| | | |
|---|---|---|
| Resolution | Base layer | QCIF |
| | Enhancement | CIF |
| | layer | |

| | |
|---|---|
| Frame Rate | 15 Hz |
| Coding Options | TZSearch ME used |
| | MV search range of ±32 pels |
| | RDO on |
| | One reference frame used |
| | Quarter pel MV resolution |
| Software | JSVM 8.10 |

Testing has been performed using five standard test sequences: “Foreman”, “Bus”, “City”, “Crew” and “Soccer”. The GOP size has been set to be 32. The coding type of all the sequences is “IBBBB”. Quantization parameters ranging from 28 to 40 have been used. For the sake of clarity, only the two-layer case is considered, in which the same quantization parameter value has been used for both the base layer and the enhancement layer. All the five sequences are 32 frames long, and the sequences have been chosen to reflect both large and small motions.

The performance metrics adopted in the testing include average time complexity reduction, PSNR Y and bit rate reduction. Time complexity reduction (TCR) is used to measure the average time saving in the encoding processes:

$$TCR = \frac{{T}_{anchor} - {T}_{proposed}}{{T}_{anchor}} \times 100 \% \qquad ( 6 )$$

where T_{anchor} is the encoding time of original JSVM 8.10 encoder and T_{proposed} is encoding time of the modified encoder according to the approach according to one embodiment described above.

From the test results, it can be seen that the proposed simplified can effectively reduce the encoding time by around 20% in average. Furthermore, the approach described above is very robust and is capable of achieving time complexity reduction over different bit rates and motion content without much PSNR degradation and bit rate increment. However, it is noted that bit rate is relatively larger for sequences such as “Soccer” and “Bus” at smaller quantization parameters. The reason is because these sequences comprise higher motion with fine details. In such cases, the motion direction correlation between the base layer and enhancement layer can become relatively lower.

The current scalable video coding performs motion estimation using all the directions such as forward, backward and bi-directional indiscriminately for base layer and enhancement layers. This exhaustive approach results in very high computational complexity and thus requires considerable processing time for encoder. In order to reduce the complexity without much quality degradation or bit rate increase, a simple yet effective and efficient motion estimation direction decision scheme is provided according to one embodiment for fast motion estimation while encoding the enhancement layers of spatially scalable SVC. Not all the coding directions are examined at the enhancement layer according to one embodiment.

The scheme can also be combined with other fast mode decision methods for realizing a real-time SVC encoder.

In one embodiment, a method of predicting the motion estimation direction of a macro block is provided comprising determining, for a first base layer macro block of a plurality of macro blocks in a base layer, a first motion estimation direction of the macro block, and determining a second motion estimation direction of a first enhancement layer macro block of a plurality of macro blocks in an enhancement layer based on the first motion estimation direction. The first enhancement layer macro block may correspond spatially to the first base layer macro block (e.g. may be associated, at least partially, with the same pixels as the first base layer macro block). The first enhancement layer macro block may have a higher number of pixels (e.g. a higher resolution) than the first base layer macro block.

The method may further include determining a third motion estimation direction of a second base layer macro block of the plurality of macro blocks in the base layer wherein the second base layer macro block is adjacent to the first base layer macro block. The method may further include determining a fourth motion estimation direction of a second enhancement layer macro block wherein the second enhancement layer macro block is adjacent to the first enhancement layer macro block. The second motion estimation direction may be determined based on the first motion estimation direction, the third motion estimation direction and/or the fourth motion estimation direction.

A motion estimation direction may for example be forward, backward, and/or bi-directional.

1. A method for encoding a digital picture of a sequence of digital pictures, the digital picture comprising a plurality of pixels, wherein the plurality of pixels is associated at least partially with a first group of pixels and the plurality of pixels is associated at least partially with at least one second group of pixels, the method comprising
determining, for the second group of pixels, a second group of pixels coding mode specifying whether pixel information of the pixels associated with the second group of pixels is to be predicted based on
pixel information of a digital picture preceding the digital picture or
pixel information of a digital picture following the digital picture or
pixel information of both a digital picture preceding the digital picture and pixel
information of a digital picture following the digital picture;
determining, for the first group of pixels, based on the second group of pixels coding mode, a first group of pixels coding mode specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel information of a digital picture following the digital picture; and
encoding the digital picture using the first group of pixels coding mode for the first group of pixels.

2. The method according to claim 1, wherein
the plurality of pixels is associated at least partially with a plurality of second groups of pixels, wherein the second group of pixels is one of the plurality of second groups of pixels,
wherein the method comprises determining, for each of the second groups of pixels, a second group of pixels coding mode specifying whether pixel information of the pixels associated with the second group of pixels is to be predicted based on
pixel information of a digital picture preceding the digital picture or
pixel information of a digital picture following the digital picture or
pixel information of both a digital picture preceding the digital picture and pixel information of a digital picture following the digital picture;
and wherein the first group of pixels coding mode is determined based on the second group of pixels coding modes determined for the second groups of pixels.

3. The method according to claim 2, wherein the second groups of pixels are associated with different pixels of the plurality of pixels.

4. The method according to claim 3, wherein the second groups of pixels are associated with disjoint subsets of the plurality of pixels.

5. The method according to claim 2, wherein the first group of pixels coding mode is determined based on a comparison of the second group of pixels coding modes.

6. The method according to claim 5, wherein it is checked whether one coding mode is equal to a majority of second group of pixels coding modes and wherein, if one coding mode is equal to a majority of second group of pixels coding modes, this coding mode is selected as the first group of pixels coding mode.

7. The method according to claim 1, wherein the first group of pixels is a group of pixels of a first coding layer corresponding to a first coding quality and the second group of pixels is a group of pixels of a second coding layer corresponding to a second coding quality.

8. The method according to claim 7, wherein the second coding layer is a base layer and the first coding layer is an enhancement layer.

9. The method according to claim 7, wherein the second group of pixels is associated with at least partially the same pixels as the first group of pixels.

10. The method according to claim 1, wherein the second group of pixels is associated with pixels adjacent to the pixels associated with the first group of pixels.

11. The method according to claim 1, wherein the second group of pixels coding mode is a second motion estimation coding direction mode specifying whether pixel information of the pixels associated with the second group of pixels is to be predicted based on a motion estimation using
pixel information of a digital picture preceding the digital picture or
pixel information of a digital picture following the digital picture or
pixel information of both a digital picture preceding the digital picture and pixel information of a digital picture following the digital picture.

12. The method according to claim 1, wherein the first group of pixels coding mode is a first motion estimation coding direction mode specifying whether pixel information of the pixels associated with the first group of pixels is to be predicted based on a motion estimation using
pixel information of a digital picture preceding the digital picture or
pixel information of a digital picture following the digital picture or
pixel information of both a digital picture preceding the digital picture and pixel information of a digital picture following the digital picture.

13. Encoder for encoding a digital picture of a sequence of digital pictures, the digital picture comprising a plurality of pixels, wherein the plurality of pixels is associated at least partially with a first group of pixels and the plurality of pixels is associated at least partially with at least one second group of pixels, the encoder comprising
a first determining circuit configured to determine a second group of pixels coding mode for the second group of pixels specifying whether pixel information of the pixels associated with the second group of pixels is to be predicted based on
pixel information of a digital picture preceding the digital picture or
pixel information of a digital picture following the digital picture or
pixel information of both a digital picture preceding the digital picture and pixel information of a digital picture following the digital picture;
a second determining circuit configured to determine a first group of pixels coding mode for the first group of pixels based on the second group of pixels coding mode specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel
information of a digital picture following the digital picture; and
an encoding circuit configured to encode the digital picture using the first group of pixels coding mode for the first group of pixels.

14. A computer program product comprising instructions which, when executed by a computer, make the computer perform a method for encoding a digital picture of a sequence of digital pictures, the digital picture comprising a plurality of pixels, wherein the plurality of pixels is associated at least partially with a first group of pixels and the plurality of pixels is associated at least partially with at least one second group of pixels, the method comprising
determining, for the second group of pixels, a second group of pixels coding mode specifying whether pixel information of the pixels associated with the second group of pixels is to be predicted based on
pixel information of a digital picture preceding the digital picture or
pixel information of a digital picture following the digital picture or
pixel information of both a digital picture preceding the digital picture and pixel
information of a digital picture following the digital picture;
determining, for the first group of pixels, based on the second group of pixels coding mode, a first group of pixels coding mode specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel
information of a digital picture following the digital picture; and
encoding the digital picture using the first group of pixels coding mode for the first group of pixels.

15. A method for encoding a digital picture of a sequence of digital pictures, the digital picture comprising a plurality of pixels, wherein the plurality of pixels is associated at least partially with a first group of pixels and another plurality of pixels of another digital picture is associated at least partially with at least one second group of pixels, the method comprising
determining, for the second group of pixels, a second group of pixels coding mode specifying whether pixel information of the pixels associated with the second group of pixels is to be predicted based on
pixel information of a digital picture preceding the other digital picture or
pixel information of a digital picture following the other digital picture or
pixel information of both a digital picture preceding the other digital picture and
pixel information of a digital picture following the other digital picture;
determining, for the first group of pixels, based on the second group of pixels coding mode, a first group of pixels coding mode specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel
information of a digital picture following the digital picture; and
encoding the digital picture using the first group of pixels coding mode for the first group of pixels.

16. An encoder for encoding a digital picture of a sequence of digital pictures, the digital picture comprising a plurality of pixels, wherein the plurality of pixels is associated at least partially with a first group of pixels and another plurality of pixels of another digital picture is associated at least partially with at least one second group of pixels, the encoder comprising
a first determining circuit configured to determine a second group of pixels coding mode for the second group of pixels, specifying whether pixel information of the pixels associated with the second group of pixels is to be predicted based on
pixel information of a digital picture preceding the other digital picture or
pixel information of a digital picture following the other digital picture or
pixel information of both a digital picture preceding the other digital picture and
pixel information of a digital picture following the other digital picture;
a second determining circuit configured to determine a first group of pixels coding mode for the first group of pixels based on the second group of pixels coding mode, specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel
information of a digital picture following the digital picture; and
an encoding circuit configured to encode the digital picture using the first group of pixels coding mode for the first group of pixels.

17. A computer program product comprising instructions which, when executed by a computer, make the computer perform a method for encoding a digital picture of a sequence of digital pictures, the digital picture comprising a plurality of pixels, wherein the plurality of pixels is associated at least partially with a first group of pixels and another plurality of pixels of another digital picture is associated at least partially with at least one second group of pixels, the method comprising
determining, for the second group of pixels, a second group of pixels coding mode specifying whether pixel information of the pixels associated with the second group of pixels is to be predicted based on
pixel information of a digital picture preceding the other digital picture or
pixel information of a digital picture following the other digital picture or
pixel information of both a digital picture preceding the other digital picture and
pixel information of a digital picture following the other digital picture;
determining, for the first group of pixels, based on the second group of pixels coding mode, a first group of pixels coding mode specifying whether pixel information of the pixels associated with the first group of pixels is to be predicted based on
pixel information of a digital picture preceding the digital picture or
pixel information of a digital picture following the digital picture or
pixel information of both a digital picture preceding the digital picture and pixel
information of a digital picture following the digital picture; and
encoding the digital picture using the first group of pixels coding mode for the first group of pixels.
